(19) United States
(12) Patent Application Publication
(10) Pub. No.: US 2015/0215808 A1
(43) Pub. Date: Jul. 30, 2015

(54) SHARING POWER CONSUMPTION FOR MOBILE GATEWAY FUNCTIONALITY IN A WLAN MESH NETWORK

(71) Applicant: Sony Corporation, Tokyo (JP)

(72) Inventors: Kristoffer Karlsson, Lund (SE); Per Åstrand, Lund (SE); Henrik Bengtsson, Lund (SE)

(73) Assignee: Sony Corporation, Tokyo (JP)

(21) Appl. No.: 14/168,218

(22) Filed: Jan. 30, 2014

(51) Int. Cl. H04W 28/02; H04W 72/04

(52) U.S. Cl. CPC H04W 28/0221; H04W 72/048; H04W 88/16

(57) ABSTRACT

The invention is directed to transferring assignment of mobile gateway functionality from a first client to a second client in a network. An exemplary method comprises determining, by a controller, a current power level of the first client, wherein mobile gateway functionality is currently assigned to the first client; determining, by the controller, the current power level of the first client is less than or equal to a threshold power level; and transferring, by the controller, assignment of the mobile gateway functionality from the first client to the second client.

### BACKGROUND

A client in a network environment may be used as a gateway that enables communication between other clients and a controller. However, the client may be a mobile client that runs on a battery source with limited capacity. Thus, to ensure that a mobile client is available as a gateway to enable communication between other clients and a controller, there is a need to manage a network environment where multiple clients run on battery sources with limited power capacities (also referred to herein as “limited power sources”).

### BRIEF SUMMARY

Embodiments of the invention are directed to a system, method, and computer program product for transferring assignment of a mobile gateway from a first client to a second client. An exemplary method comprises determining, by a controller, a current power level of the first client, wherein mobile gateway functionality is currently assigned to the first client; determining, by the controller, the current power level of the first client is less than or equal to a threshold power level; and transferring, by the controller, assignment of the mobile gateway functionality from the first client to the second client.

In some embodiments, the power level is associated with a limited power source.

In some embodiments, the power level is associated with a battery.

In some embodiments, upon the second client being assigned the mobile gateway functionality, the second client communicates with the controller via long-range wireless protocol.

In some embodiments, the first client communicates with the second client via Wi-Fi Direct.

In some embodiments, the first client communicates with the second client via short-range wireless protocol.

In some embodiments, the mobile gateway functionality is assigned to a second client, and not a third client, based on a power level associated with the second client being greater than a power level associated with the third client.

In some embodiments, the first client or the second client comprises a mobile phone, a mobile computing device, a mobile television, a laptop computer, a smart screen, a tablet computer, a portable desktop computer, an e-reader, a scanner, a portable media device, eyewear, a gaming device, a camera, a watch, or a band or other wearable device.

In some embodiments, a method is provided for assigning mobile gateway functionality to a first client. The method comprises: determining, by a controller, a current power level of the first client and a second client; determining, by the controller, the current power level of the first client is greater than the power level of the second client; and assigning, by the controller, mobile gateway functionality to the first client.

In some embodiments, the second client connects to the controller via the first client.

In some embodiments, the second client connects to the first client via Wi-Fi Direct.

In some embodiments, the first client connects to the controller via a wireless protocol.

In some embodiments, a system is provided for transferring assignment of mobile gateway functionality from a first client to a second client. The system comprises a memory; a processor; and a module stored in the memory, executable by the processor, and configured to determine a current power level of the first client, wherein mobile gateway functionality is currently assigned to the first client; determine the current power level of the first client is less than or equal to a threshold power level; and transfer assignment of the mobile gateway functionality from the first client to the second client.

In some embodiments, the system communicates with the first client via wireless protocol when mobile gateway functionality is assigned to the first client.

In some embodiments, the system communicates with the first client via the second client when mobile gateway functionality is assigned to the second client.

In some embodiments, a computer program product is provided for executing the various processes or methods described herein. The computer program product comprises a non-transitory computer-readable medium comprising code configured to perform the various processes or methods described herein.

### BRIEF DESCRIPTION OF THE DRAWINGS

Having thus described embodiments of the invention in general terms, reference will now be made to the accompanying drawings, where:

FIGS. 1A and 1B illustrate exemplary network environments, in accordance with embodiments of the present invention;

FIG. 2 illustrates an exemplary process flow for transferring assignment of a mobile gateway from a first client to a second client, in accordance with embodiments of the present invention; and

FIG. 3 illustrates an exemplary process flow for assigning mobile gateway functionality to a first client, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

The present invention is directed to rotating assignment of a gateway based on current power levels of clients connected to the gateway and based on a current power level of the gateway. The present invention is directed to wireless networks, and is not limited to any particular wireless protocol. Exemplary wireless protocol includes Long Term Evolution (LTE), Wide Area Networks (WAN), etc.

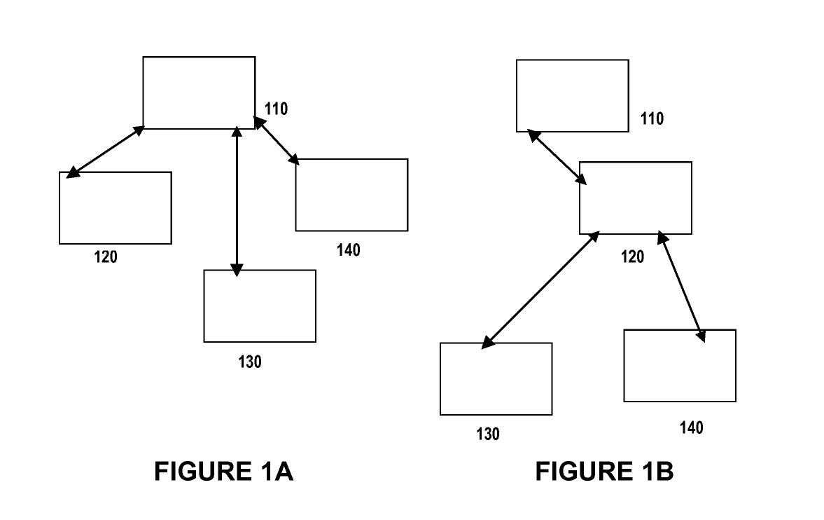

Referring now to FIG. 1A, FIG. 1A presents a network comprising a controller 110 (e.g., a router associated with a network), a first client 120, a second client 130, and a third client 140. The network can be connected in a mesh structure, i.e., one client is connected to one or more other clients in an ad-hoc manner. For example, the network may be a wireless local area network (WLAN). An exemplary network is a cellular network. The first client 120, second client 130, and third client 140 connect to the controller 110 via wireless protocol. The controller 110 may be an access point associated with the network.

Referring now to FIG. 1B, FIG. 1B presents a network environment where the controller 110 selects one of the clients (e.g., the first client 120) as the gateway and commands the other clients (e.g., the second client 130 and the third client 140) to connect to the gateway. The controller 110 selects the first client 120 as the gateway because the first client 120 has a greater power level (or power capacity) compared to the second 130 and third 140 clients. Upon selecting the first client 120 as the gateway, either the controller 110 or the first client 120 indicates to the second 130 and third 140 clients that the second 130 and third 140 clients need to now communicate with the controller 110 via the gateway (i.e., the first client 120). The communication between the gateway and the other clients (i.e., the second 120 and third 140 clients) is based on a Wi-Fi Direct connection or any other short-range wireless connection (e.g., Bluetooth). Wi-Fi Direct is a Wi-Fi standard that enables clients to connect with each other without requiring a wireless access point (e.g., a router or a system connected to a router). As used herein, the gateway may also be referred to as the mobile gateway. As used herein, the range associated with long-range wireless protocol and long-range wireless connections is greater than the range associated with short-range wireless protocol and short-range wireless connections.

Since the execution of gateway functionality consumes a lot of power, the present invention is directed to enabling the controller 110 to switch the gateway from the first client 120 to the second client 130 or third client 140 based on power levels associated with the first client 120, the second client 130, and the third client 140. The present invention assumes that the first client 120, second client 130, and third client 140 include limited power sources or power sources with limited capacities (e.g., batteries). The first client 120, second client 130, and third client 140 may be mobile clients. Exemplary mobile clients are specified later in the specification. In some embodiments, the controller 110 is not a mobile client and is connected to a continuous source of power.

The controller 110 monitors the power levels of the gateway and at least one of the clients in communication with the gateway. The controller 110 also monitors how much power the gateway has consumed from the time when the gateway was assigned the function of performing as a gateway (or gateway functionality). The clients communicate their power levels to the controller 110 either with or without a request being sent from the controller 110 to the clients for updates on their power levels. For example, the clients may periodically communicate their power levels to the controller 110. The power levels are either directly communicated to the controller 110 or are communicated to the controller 110 via the gateway. When a predetermined amount of power has been consumed by the gateway (or when the gateway reaches a predetermined critical power level), the controller 110 selects a new gateway from among the clients and allows the current gateway to become a client. The client selected as the new gateway is selected based on determining that the client has a higher power level compared to the power levels of other clients in the network environment. Therefore, the present invention enables periodic reassignment of the gateway based on the power levels of the gateway and other clients in the network environment.

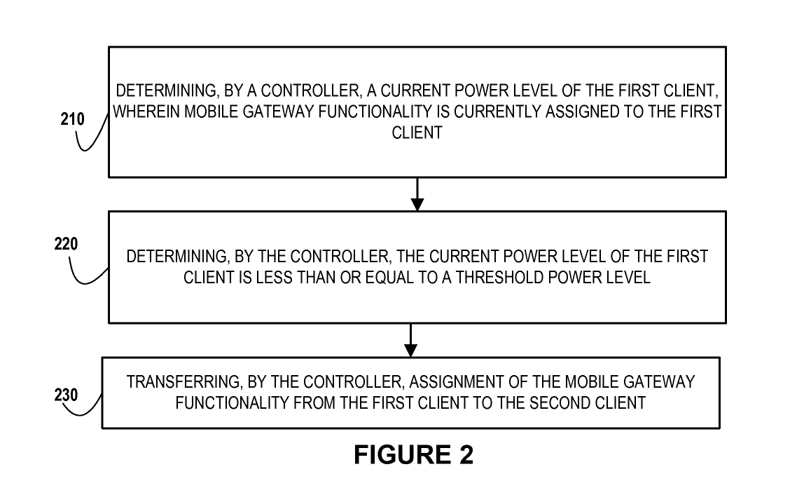

Referring now to FIG. 2, FIG. 2 describes an exemplary process flow for transferring assignment of a mobile gateway from a first client to a second client. At step 210, the process flow comprises determining, by a controller, a current power level of the first client, wherein mobile gateway functionality is currently assigned to the first client. At step 220, the process flow comprises determining, by the controller, the current power level of the first client is less than or equal to a threshold power level. At step 230, the process flow comprises transferring, by the controller, assignment of the mobile gateway functionality from the first client to the second client. The power level is associated with a limited power source (e.g., a battery). In some embodiments, the mobile gateway functionality is assigned to a second client, and not a third client, based on a power level associated with the second client being greater than a power level associated with the third client. When the second client is assigned mobile gateway functionality, the second client communicates with the controller via long-range wireless protocol, and communicates with the first client via Wi-Fi Direct or other short-range wireless protocol.

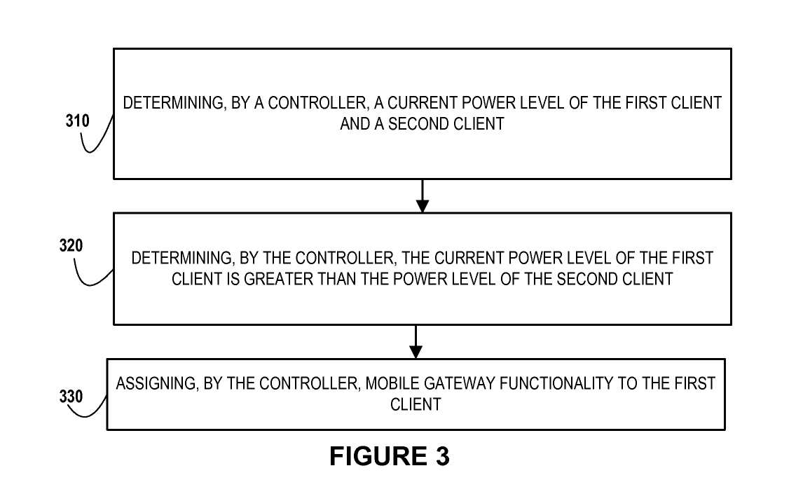

Referring now to FIG. 3, FIG. 3 describes an exemplary process flow for assigning mobile gateway functionality to a first client. At step 310, the process flow comprises determining, by a controller, a current power level of the first client and a second client. At step 320, the process flow comprises determining, by the controller, the current power level of the first client is greater than the power level of the second client. At step 330, the process flow comprises assigning, by the controller, mobile gateway functionality to the first client. The second client connects to the controller via the first client. The first client connects to the controller via a wireless protocol. The second client connects to the first client via Wi-Fi Direct.

As used herein, a client may refer to a device or a system. The invention is not limited to any particular types of clients. Examples of clients include mobile phones or other mobile computing devices, mobile televisions, laptop computers, smart screens, tablet computers or tablets, portable desktop computers, e-readers, scanners, portable media devices, eyewear, gaming devices, cameras or other image-capturing devices, watches, bands (e.g., wristbands) or other wearable devices, or other portable or non-portable computing or non-computing devices.

Each client, gateway, and controller described herein comprises a processor, a memory, and a module stored in the memory, executable by the processor, and configured to perform the various processes described herein. Each processor described herein generally includes circuitry for implementing audio, visual, and/or logic functions. For example, the processor may include a digital signal processor client, a microprocessor client, and various analog-to-digital converters, digital-to-analog converters, and other support circuits. Control and signal processing functions of the system (e.g., first client or second client) in which the processor resides may be allocated between these clients according to their respective capabilities. The processor may also include functionality to operate one or more software programs based at least partially on computer-executable program code portions thereof, which may be stored, for example, in a memory.

Each memory described herein may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

In accordance with embodiments of the invention, the term “module” with respect to a system (or a client) may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, client, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, client, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage client. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for transferring assignment of mobile gateway functionality from a first client to a second client, the method comprising:
determining, by a controller, a current power level of the first client, wherein mobile gateway functionality is currently assigned to the first client;
determining, by the controller, the current power level of the first client is less than or equal to a threshold power level; and
transferring, by the controller, assignment of the mobile gateway functionality from the first client to the second client.

2. The method of claim 1, wherein the power level is associated with a limited power source.

3. The method of claim 1, wherein the power level is associated with a battery.

4. The method of claim 1, wherein the second client communicates with the controller via long-range wireless protocol upon the second client being assigned the mobile gateway functionality.

5. The method of claim 1, wherein the first client communicates with the second client via Wi-Fi Direct.

6. The method of claim 1, wherein the first client communicates with the second client via short-range wireless protocol.

7. The method of claim 1, wherein the mobile gateway functionality is assigned to a second client, and not a third client, based on a power level associated with the second client being greater than a power level associated with the third client.

8. The method of claim 1, wherein the first client or the second client comprises a mobile phone, a mobile computing device, a mobile television, a laptop computer, a smart screen, a tablet computer, a portable desktop computer, an e-reader, a scanner, a portable media device, eyewear, a gaming client, a camera, a watch, or a band or other wearable device.

9. A method for assigning mobile gateway functionality to a first client, the method comprising:
determining, by a controller, a current power level of the first client and a second client;
determining, by the controller, the current power level of the first client is greater than the power level of the second client; and
assigning, by the controller, mobile gateway functionality to the first client.

10. The method of claim 9, wherein the second client connects to the controller via the first client.

11. The method of claim 9, wherein the second client connects to the first client via Wi-Fi Direct.

12. The method of claim 9, wherein the first client connects to the controller via a wireless protocol.

13. A system for transferring assignment of mobile gateway functionality from a first client to a second client, the system comprising:
a memory;
a processor;
a module stored in the memory, executable by the processor, and configured to:
determine a current power level of the first client, wherein mobile gateway functionality is currently assigned to the first client;
determine the current power level of the first client is less than or equal to a threshold power level; and
transfer assignment of the mobile gateway functionality from the first client to the second client.

14. The system of claim 13, wherein the system communicates with the first client via a wireless protocol when mobile gateway functionality is assigned to the first client.

15. The system of claim 13, wherein the system communicates with the first client via the second client when mobile gateway functionality is assigned to the second client.
